(19) United States
(12) Patent Application Publication
(10) Pub. No.: US 2005/0019449 A1
(43) Pub. Date: Jan. 27, 2005

(54) Confectionery device

(76) Inventor: Jonathan P. Wilder, South Pasadena, CA (US)

Correspondence Address: Jonathan Wilder, 1424 Laurel Avenue, South Pasadena, CA, 91030, US

(21) Appl. No.: 10/837,286

(22) Filed: Apr. 29, 2004

Related U.S. Application Data
(60) Provisional application No. 60/466,476, filed on Apr. 29, 2003.

(51) Int. Cl. A23G 3/00

(52) U.S. Cl. 426/90

(57) ABSTRACT

The present invention is a confectionery device having at least two engaging portions specifically adapted to engage a receiving-side on the outer crown and a receiving-side formed on the mouthpiece-side at end of a hollow closed in barrel. The portion that remains open will slide over a decorated object. The decorated object will tightly fit into place with a friction fit due to the air channels located at the end of the barrel. The exterior of the confectionery device is comprised of two sections; the crown and base. The crown of the confectionery device is constructed and adapted to receive and securely embrace confections of all shapes and sizes. The base of the confectionery device is less adapted to embrace confections while its smooth surface allows children of all ages to enjoy their confection in a safe and hygienic manner. All in all when the confectionery device is adapted to a decorative rod while embracing a confection, it forms an attractive lollipop aiding in the amusement of eating a candy.

### BACKGROUND

In the past a great variety of toys and devices to hold confections have been developed, each providing different ways of amusement based on size, shape, sound, motion, light emission, in some cases even combining one or more of those features as the inventions and designs reference.

However, some toys are not suitable to be handled by most children, and none of them make use of the advantages of a transparent adapter-like device to adhere to a variety of different articles. The invention is well adapted to fit over articles of the type comprising stems, shafts, posts narrow flat objects and the like. Known in the art are stem like articles such as pencils, pens, markers, and other writing instruments. Other stem like items are decorated wood dowel sticks, reflective sticks, light rods, laser pointers, flashlights, light sticks and the like.

Confections can be enjoyed with more amusement now with unnatural stem like objects adapted with a transparent device that is hardly noticeable.

### SUMMARY

The present invention relates to an adapter as a confection holding toy to form unique lollipops. Confections introduced to a transparent tubular device to which the candy is securely fixed in a proper way. The unique duel exterior of the device allow the confection to be attached securely while not affecting the enjoyment of confections.

Another feature of this device is its unique interior design. Stem like objects not normally associated with candy can now be inserted into the transparent device made possible by the air channel knobs, which secure the objects into place. Pencils have led, eraser and metal at the ends so naturally they can not be used alone as a handle for lollipops. Light-sticks, laser pointers and other writing instruments are also uncommon as handles without the use of the device.

The presence and effect of handle like objects is not impeded because of the contour shape and transparency of the present invention. Therefore light and designs of the objects inserted into the invention will not be hindered which can add fun to the action of eating such candies in an unusual way, which constitutes the main novelty feature of the present invention.

Further more, this invention gives special attention to the safety and hygienic aspects of the toy intended for little children not only providing an engineered single piece design which makes it unlikely for accidental and dangerous breaking or disassembling.

Some other design and advantageous features of the present invention will become evident through the following description analyzing the illustrating drawings.

### DRAWINGS

The foregoing and still other objects of this invention will become fully apparent, as well as various advantages and features of novelty residing in the present embodiments, from study of the following description of some currently preferred configurations wherein of reference are shown to match related points in the text, as well as in the annexed claims hereto; and accordingly, a better understanding of the invention and the discovered uses is intended, by reference to the drawings, which are considered as primarily exemplary and not restrictive in nature.

FIG. 1, is a perspective view of the present invention standing alone.

FIG. 2, is a rear interior view of the present invention taken from the FIG. 1 as indicated.

FIG. 3, is a top view of the present invention.

FIG. 4, is a front exterior view of the present invention taken from the FIG. 1 as indicated.

FIG. 5, is a schematic view of the present invention connecting a confection to a decorated light-stick.

FIG. 6, is a schematic view of a confection assembly with the present invention attached to a pencil.

FIG. 7, schematically illustrates an exploded view of the confection assembly with the present invention attached to a pencil as previously illustrated in FIG. 6.

### DETAILED DESCRIPTION

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary, the intent is to cover all alternatives, modifications and equivalents included within the spirit and scope of the invention as defined by the appended claims.

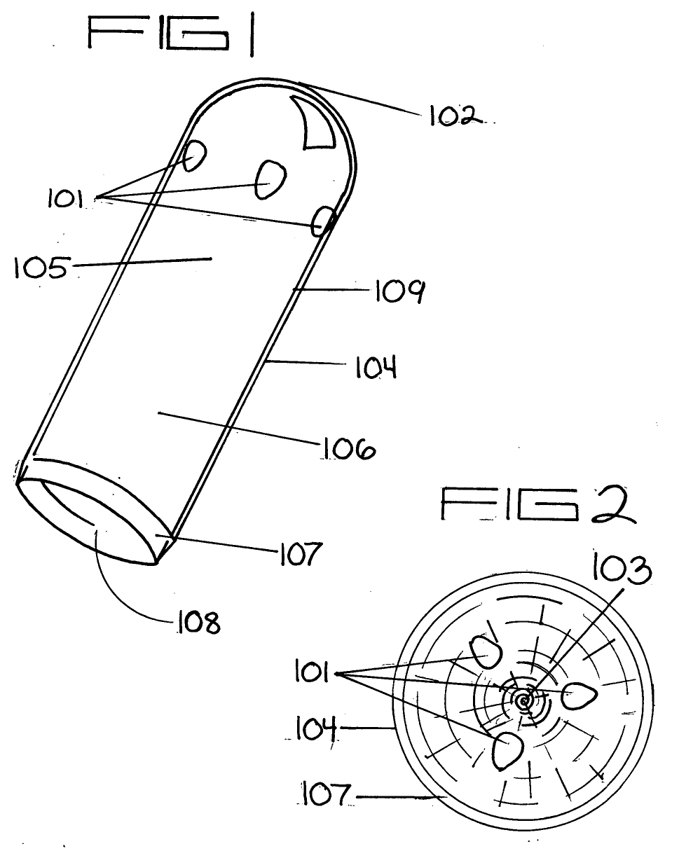

Turning now to the drawings, reference is made to FIG. 1, illustrated is a perspective view of the present invention as it would appear standing alone. While alone we are able to see some of the unique features of this marvelous invention. Bottom left, in FIG. 1, illustrated is the entrance to the receiving bore cavity 108 which allows a stem-like object as described above to slide securely inside the present invention held in with three air channel knobs 101 built into the wall of the interior of the invention. The receiving bore cavity 108 forms a long cylindrical hollow tube 104 with two exterior textures rounding off at the top 102. The upper half of this transparent tubular structure 105 is slightly textured to allow confections to adhere permanently. Just as the upper half of the present invention 105 is transparent so is the lower base 106 but is extremely smooth.

FIG. 2, is a view directly behind the present invention allowing us to see directly into the receiving bore cavity 108. As described in FIG. 1, FIG. 2, shows how easily a stem-like handle object can slide inside the interior wall 109 of the long tubular shaft portion of the present invention to the top 103 all while being tightly in place with a permanent friction fit made possible by the three air channel knobs 101.

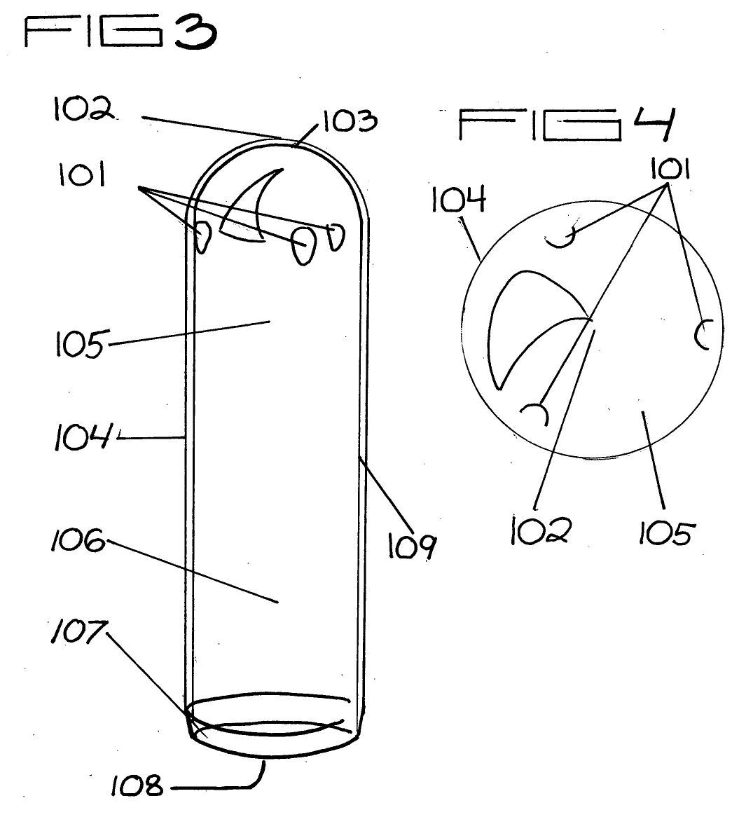

As illustrated along the top of the drawing of the present invention in FIG. 3 shown is the entire device manufactured with 100% FDA approved high-heat transparent plastic. Because of the transparency we are able to see through the exterior of the present invention into the three unique air channel knobs 101 on the interior wall lining. As indicated in FIG. 1 the exterior has two surfaces, slightly textured at the top half of the device 105 and very smooth at the base 106. Because the textures are so slight it is not noticeable at first look. The exterior rim 107 of the receiving bore cavity 108 is tapered at a 30-degree angle up the base of the cylindrical tube 106. The tapering makes for a much more slight change from the exterior of the present invention 104 to the exterior of a stem-like object inserted inside receiving bore cavity 108 to be used as a handle.

In FIG. 4, is a drawing of the front exterior of the present invention as indicated in FIG. 1. In the center illustration of FIG. 4, is the crown 102 of the present invention. The crown is specifically designed to be spherical because of the strength it provides as opposed to a square or triangular design. Not only do they not provide the proper strength but sharp angles can be harmful as someone is consuming a confection attached to the present invention.

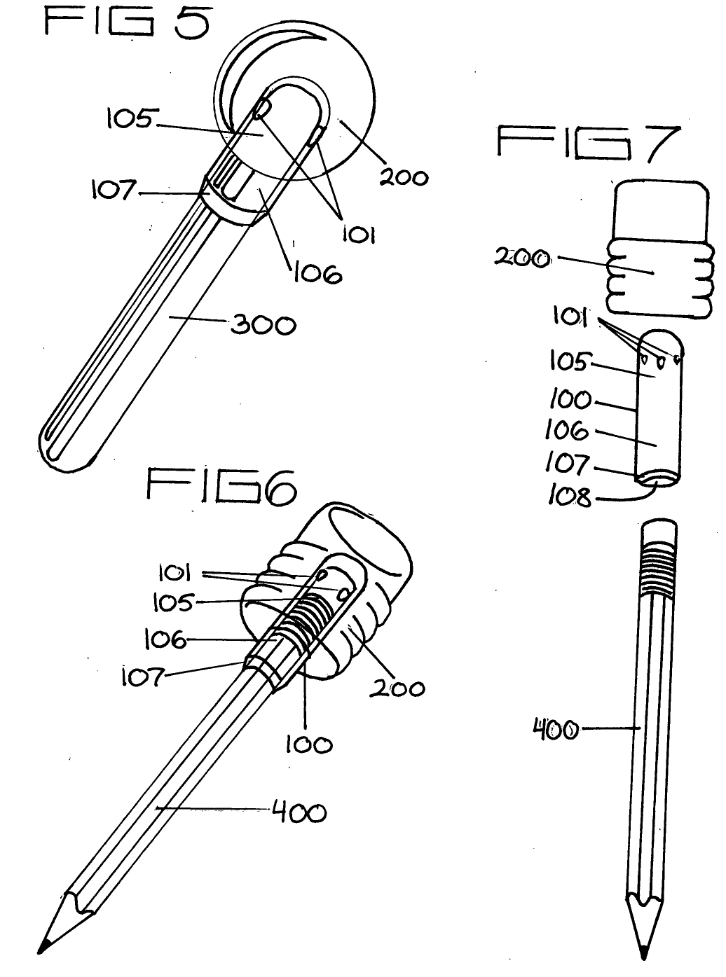

Illustrated in FIG. 5, the present invention is being used as an adapter to a transparent confection 200 and a stem-like handle device 300 made reference to with a decorative light-stick. Illustrations on the decorative light-stick 300 are easily seen through both the present invention and a transparent confection 200. When adapted properly as illustrated in FIG. 5, the stem-like handle and confection atop the present invention for a unique novelty lollipop.

In FIG. 6, a pencil 400 combined with the adaptive confectionery device 100 holding a shaped hard candy confection 200 makes another interesting novelty lollipop as previously indicated in FIG. 5, with a decorative light-stick. The illustration in FIG. 6, clearly shows how the transparent present invention 100 not only combines a tasty treat of a confection to an unnatural lollipop handle while the transparency and relative shape to the stem-like handle 400 will not take away from the shape, color and overall function of the pencil. Indicated previously, the tapered rim of the lower exterior portion of the present invention 107 brings the exterior of the pencil 400 together in a much more subtle transition. The tapered end also makes it very difficult for someone to pull the present invention 100 off the stem-like handle 400 as illustrated with a pencil.

In FIG. 7, illustrated is an exploded view of what was previously illustrated in FIG. 6. This illustration shows the features of the confection 200 the present invention 100 and the stem-like handle referenced with a pencil 400.

Accordingly, it is understood that the utility of the foregoing adaptations of this invention is not dependent upon any prevailing invention patent necessarily, and while the present invention has been well described hereinbefore by way of several exemplified preferred embodiments, it should be realized that various changes, rearrangements, or obvious modifications are still possible by those skilled in the art to which it relates, without substantially departing from the implied spirit and scope of the invention.

1. An adapter article to connect edible confections to non-edible handle like objects comprising of:
A hollow plastic tube like apparatus with a rounded closed in top end and an inner bore cavity at the bottom;
complete with air channels to grasp stem-like objects.

2. An adapter article to connect edible confections to non-edible handle like objects as described in claim 1, in which a slight texture encapsulates the top exterior;
with a non-texture smooth surface of the lower half of the exterior;
and inner bore cavity with three air channel knobs along the inner wall.

3. An adapter article to connect edible confections to non-edible handle like objects as described in claim 1, is comprised of a single piece of transparent Food and Drug Administration approved plastic.
